(19) United States
(12) Patent Application Publication
(10) Pub. No.: US 2023/0073165 A1
(43) Pub. Date: Mar. 9, 2023

(54) HOUSING FOR ELECTRIC POWER STEERING DEVICE

(71) Applicant: HITACHI ASTEMO, LTD., Hitachinaka-shi, Ibaraki (JP)

(72) Inventor: Masatoshi ENOMOTO, Hitachinaka-shi, Ibaraki (JP)

(73) Assignee: HITACHI ASTEMO, LTD., Hitachinaka-shi, Ibaraki (JP)

(21) Appl. No.: 17/799,229

(22) PCT Filed: Feb. 5, 2021
(86) PCT No.: PCT/JP2021/004311

§ 371 Date: Aug. 11, 2022

(30) Foreign Application Priority Data
Feb. 17, 2020 (JP) 2020-024500

(51) Int. Cl. B62D 5/04; F16H 19/04; F16H 25/22

(52) U.S. Cl. CPC B62D 5/0448; B62D 5/0424; F16H 19/04; F16H 25/22

(57) ABSTRACT

A housing for an electric power steering device that has an electric motor, a speed reduction mechanism, a ball screw mechanism, and a rack bar. The housing has a first housing having a first end portion covering a part of the rack bar and a second end portion with a portion accommodating at least a part of the speed reduction mechanism. The first housing includes a rack bar insertion hole portion; an electric motor shaft insertion hole portion having a cylindrical shape on a radially outer side of the rack bar insertion hole portion, through which an electric motor shaft is inserted; and a fastening portion having an annular shape overlapping with an inner peripheral surface of the electric motor shaft insertion hole portion along the longitudinal direction of the rack bar when an axis extending in the rack bar longitudinal direction is viewed from a radially outer side.

### TECHNICAL FIELD

The present invention relates to a housing for an electric power steering device.

### BACKGROUND ART

In Patent Literature 1, there is disclosed a housing for an electric power steering device.

### CITATION LIST

### Patent Literature

PTL 1: JP 2019-055735 A

### SUMMARY OF INVENTION

### Technical Problem

However, a structure of the housing for an electric power steering device which is described in Patent Literature 1 has the following problem. When a high load is applied to the housing, a fastening axial force may lose balance due to deformation caused by an uneven thickness of an outer peripheral portion of a screw, resulting in loosening of a lock nut.

One object of the present invention is to provide a housing for an electric power steering device, which can ensure a uniform fastening axial force.

### Solution to Problem

According to one embodiment of the present invention, there is provided a housing for an electric power steering device, the electric power steering device including: an electric motor; a speed reduction mechanism configured to reduce a speed of an output from the electric motor; a ball screw mechanism configured to convert a rotational motion transmitted from the speed reduction mechanism into a linear motion; and a rack bar connected to the ball screw mechanism, the housing including: a first housing having a first end portion configured to cover a part of the rack bar and a second end portion with a mechanism accommodating portion configured to accommodate at least a part of the speed reduction mechanism; and a second housing having a first end portion with a closing portion configured to close the mechanism accommodating portion and a second end portion configured to cover a part of the rack bar, wherein the first housing includes: a rack bar insertion hole portion through which the rack bar is inserted in a longitudinal direction of the rack bar; an electric motor shaft insertion hole portion having a cylindrical shape on a radially outer side of the rack bar insertion hole portion, through which an electric motor shaft extending from the electric motor is inserted; and a fastening portion having an annular shape, which overlaps with an inner peripheral surface of the electric motor shaft insertion hole portion in the longitudinal direction of the rack bar when an axis extending in the longitudinal direction of the rack bar is viewed from a radially outer side, and is configured to allow the ball screw mechanism to be fixed into the rack bar insertion hole portion.

### Solution to Problem

Thus, the housing for an electric power steering device according to one embodiment of the present invention can ensure a uniform fastening axial force.

### BRIEF DESCRIPTION OF DRAWINGS

FIG. 1 is an overall configuration view of an electric power steering device according to a first embodiment.

FIG. 2 is a sectional view of a ball screw mechanism and a speed reduction mechanism taken in an axial direction, which passes through an axis extending in a longitudinal direction of a rack bar according to the first embodiment.

FIG. 3 is a plan view of a first housing according to the first embodiment as viewed from its second end side.

FIG. 4 is a sectional view taken along the line D-D of FIG. 3 as viewed in a direction of arrows.

FIG. 5 is a sectional view taken along the line E-E of FIG. 3 as viewed in a direction of arrows.

FIG. 6 is a sectional view taken along the line F-F of FIG. 3 as viewed in a direction of arrows.

FIG. 7 is an enlarged view of an area C of FIG. 3.

FIG. 8 is an enlarged sectional view of an area G of FIG. 4.

FIG. 9 is an enlarged sectional view of an area H of FIG. 5.

FIG. 10 is an enlarged sectional view of an area I of FIG. 6.

### DESCRIPTION OF EMBODIMENTS

A description is made below of embodiments of the present invention with reference to the drawings.

### First Embodiment

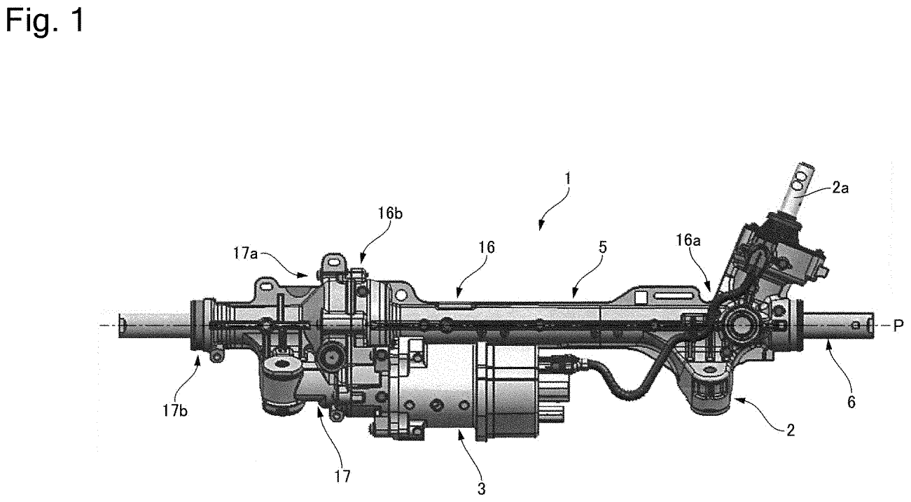

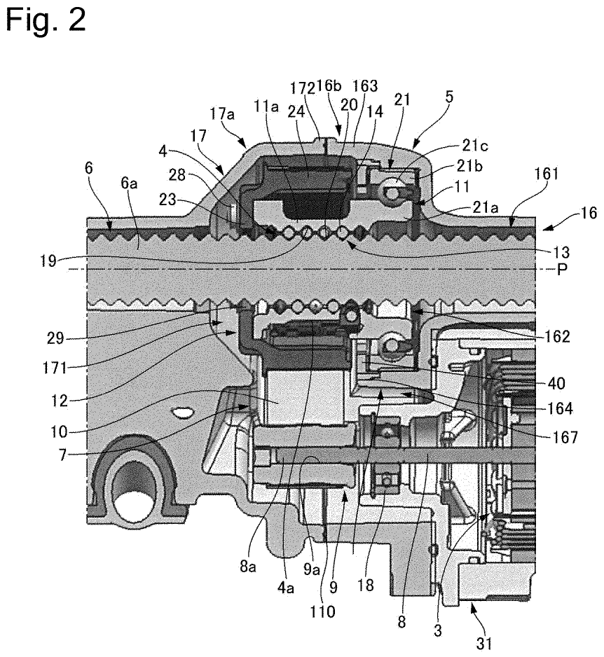

FIG. 1 is an overall configuration view of an electric power steering device according to a first embodiment. FIG. 2 is a sectional view of a ball screw mechanism and a speed reduction mechanism taken in an axial direction, which passes through an axis extending in a longitudinal direction of a rack bar according to the first embodiment.

(Overall Configuration of Electric Power Steering Device)

An electric power steering device 1 according to the first embodiment is mounted in a vehicle including an engine as a power source.

The electric power steering device 1 includes a steering mechanism 2, an electric motor 3, a ball screw mechanism 4, a speed reduction mechanism 7, and a housing 5.

The steering mechanism 2 steers front wheels being steered wheels. The steering mechanism 2 includes a rack bar 6.

The rack bar 6 is a steering shaft extending in a width direction of a vehicle body (right-and-left direction of FIG. 1), and is made of an iron-based metal material such as a steel material.

The rack bar 6 has a main body portion 6a extending in the width direction of the vehicle body.

The rack bar 6 moves in the width direction of the vehicle body in accordance with rotation of a steering shaft 2a connected to a steering wheel (not shown). The front wheels are connected to both ends of the rack bar 6 through intermediation of tie rods (not shown), respectively.

The electric motor 3 applies a steering force to the steering mechanism 2. The electric motor 3 is, for example, a three-phase brushless motor.

An electric motor control unit (not shown) controls an output from the electric motor 3 in accordance with a steering torque input to the steering wheel (not shown) by a driver or a vehicle velocity.

An electric motor pulley 9 is mounted on an electric motor shaft 8 of the electric motor 3.

One side of an endless belt 10 is wound around an outer periphery of the electric motor pulley 9.

The ball screw mechanism 4 is provided between the steering mechanism 2 and the electric motor 3.

The ball screw mechanism 4 converts a rotational force of the electric motor 3 into a thrust force for the steering mechanism 2.

The ball screw mechanism 4 includes a nut 11. The nut 11 includes a tubular main body portion 11a having a substantially cylindrical shape that surrounds the rack bar 6.

A nut pulley 12 is provided on an outer periphery of the nut 11. The nut pulley 12 rotates together with the nut 11. A rotation axis of the nut pulley 12 matches a rotation axis (axis P extending in a longitudinal direction of the rack bar 6) of the nut 11.

The rotation axis of the nut 11 and the nut pulley 12 is offset from a rotation axis of the electric motor pulley 9 in a radial direction of the electric motor pulley 9.

A diameter of the nut pulley 12 is larger than a diameter of the electric motor pulley 9.

Another side of the endless belt 10 is wound around an outer periphery of the nut pulley 12.

The nut pulley 12, the electric motor pulley 9, and the endless belt 10 form the speed reduction mechanism 7. The electric motor pulley 9 has a diameter smaller than a diameter of the nut pulley 12. The endless belt 10 is looped over both of the pulleys 12 and 9.

The nut 11 is supported so as be rotatable with respect to the housing 5 and unmovable in the axial direction.

Ball circulation grooves 13 are formed in an inner periphery of the nut 11 and an outer periphery of the rack bar 6.

A plurality of balls 14 are placed inside the ball circulation grooves 13. Each of the balls 14 moves toward one end or another end of a set of the ball circulation grooves 13 in accordance with the rotation of the nut 11.

The balls 14 that have reached one end or another end of the set of the ball circulation grooves 13 through the rotation of the nut 11 are returned to another end or one end of the set of the ball circulation grooves 13 via a tube 4a being a circulation mechanism.

The housing 5 is made of an aluminum alloy and formed by die casting.

The housing 5 includes a first housing 16 and a second housing 17. The first housing 16 has a first end portion 16a and a second end portion 16b. The first end portion 16a covers a part of the rack bar 6, and the second end portion 16b has a mechanism accommodating portion 162 that accommodates at least a part of the ball screw mechanism 4 and the speed reduction mechanism 7. The second housing 17 has a first end portion 17a and a second end portion 17b. The first end portion 17a has a mechanism accommodating portion 171 and a closing portion 172. The mechanism accommodating portion 171 accommodates at least a part of the ball screw mechanism 4 and the speed reduction mechanism 7. The closing portion 172 closes the mechanism accommodating portion 162 of the first housing 16. The second end portion 17b covers a part of the rack bar 6. Further, the first housing 16 has a rack bar insertion hole portion 161, an electric motor shaft insertion hole portion 167, and a female thread portion (fastening portion) 164. The rack bar 6 is inserted through the rack bar insertion hole portion 161 in the longitudinal direction of the rack bar 6. The electric motor shaft insertion hole portion 167 is formed on a radially outer side of the rack bar insertion hole portion 161. The electric motor shaft 8, which is supported in an electric motor housing 31 and extends from the electric motor 3, is inserted through the electric motor shaft insertion hole portion 167 having a cylindrical shape. When the axis P extending in the longitudinal direction of the rack bar 6 is viewed from the radially outer side, the female thread portion 164 having an annular shape overlaps with an inner peripheral surface 167a of the electric motor shaft insertion hole portion 167 in the longitudinal direction of the rack bar 6. A lock nut 40 that fixes the ball screw mechanism 4 into the rack bar insertion hole portion 167 is threadedly engaged with the female thread portion 164.

As described above, the female thread portion 164 has a continuous annular shape. Thus, the female thread portion 164 can be prevented from being deformed in such a manner as to increase its diameter under a fastening load that is applied when the lock nut 40 is threadedly engaged therewith.

Further, the inner peripheral surface of the electric motor shaft insertion hole portion 167 having a cylindrical shape also has a continuous annular shape. Thus, the electric motor shaft insertion hole portion 167 has such a structure as to resist against the female thread portion 164 that is being deformed to increase its diameter under a fastening load that is applied when the lock nut 40 is threadedly engaged with the female thread portion 164. Thus, the female thread portion 164 can be further prevented from being deformed in such a manner as to increase its diameter.

The first housing 16 and the second housing 17 have a joint surface 110 at which the second end portion 16b side of the mechanism accommodating portion 162 of the first housing 16 and the first end portion 17a side of the closing portion 172 of the second housing 17 are connected to each other with use of a plurality of bolts (not shown). The joint surface 110 is defined on an extended portion 163 that is closer to the second end portion 16b of the first housing 16 than the female thread portion 164 is.

As described above, the presence of the extended portion 163, on which a fastening load does not directly act when the lock nut 40 is threadedly engaged with the female thread portion 164, can further reliably prevent the female thread portion 164 from being deformed in such a manner as to increase its diameter under a fastening load that is applied when the lock nut 40 is threadedly engaged therewith.

The electric motor shaft 8 of the electric motor 3 is arranged at a position offset in the radial direction from the rotation axis of the nut 11 (the axis P extending in the longitudinal direction of the rack bar 6). The electric motor shaft 8 is supported in a ball bearing 18 fixed in the electric motor housing 31 fixed to the first housing 16.

The motor pulley 9 is made of a metal material and formed in a cylindrical shape.

The motor pulley 9 has a spline hole 9a in its center in the radial direction. A spline 8a at a distal end of the electric motor shaft 8 is fitted into the spline hole 9a.

The nut 11 is rotatably provided in the mechanism accommodating portion 162 of the first housing 16 and the mechanism accommodating portion 171 of the second housing 17.

A center portion of the tubular main body portion 11a of the nut 11 in a direction of the axis P extending in the longitudinal direction of the rack bar 6 is set to have a diameter smaller than a diameter of each of end portions of the rack bar 6 in the direction of the axis P extending in the longitudinal direction of the rack bar 6.

A nut-side ball screw groove 19 having a helical pattern is formed in an inner periphery of the center portion of the tubular main body portion 11a in the direction of the axis P extending in the longitudinal direction of the rack bar 6.

Meanwhile, a rack bar-side ball screw groove 20 having a helical pattern is formed in an outer periphery of the main body portion 6a of the rack bar 6.

The nut-side ball screw groove 19 and the rack bar-side ball screw groove 20 form the ball circulation grooves 13.

An inner race 21a of a ball bearing 21 is formed integrally with a right end of the nut 11 of FIG. 2 in the direction of the axis P extending in the longitudinal direction of the rack bar 6.

The ball bearing 21 supports the nut 11 so that the nut 11 is rotatable in a circumferential direction with respect to the first housing 16.

The ball bearing 21 includes the inner race 21a, an outer race 21b, and balls 21c. The outer race 21b is fixed to the annular female thread portion 164 of the first housing 16 with the lock nut 40. The balls 21c are provided between the inner race 21a and the outer race 21b.

The nut pulley 12 is made of a metal material and is formed in a bottomed cup-like shape.

The nut pulley 12 includes a hub portion 23 and a winding portion 24. The hub portion 23 is located at a left end of the nut pulley 12 of FIG. 2 in the direction of the axis P extending in the longitudinal direction of the rack bar 6.

The hub portion 23 is formed in a substantially annular disc-like shape. The hub portion 23 is fastened to the nut 11 with four screws 28.

The hub portion 23 has a rack bar insertion hole 29 in a center in its radial direction.

The rack bar 6 passes through the rack bar insertion hole 29.

The winding portion 24 extends from an outer periphery of the hub portion 23 to a right side of FIG. 2 in the direction of the axis P extending in the longitudinal direction of the rack bar 6.

The winding portion 24 is formed in a cylindrical shape. The endless belt 10 is wound around the winding portion 24.

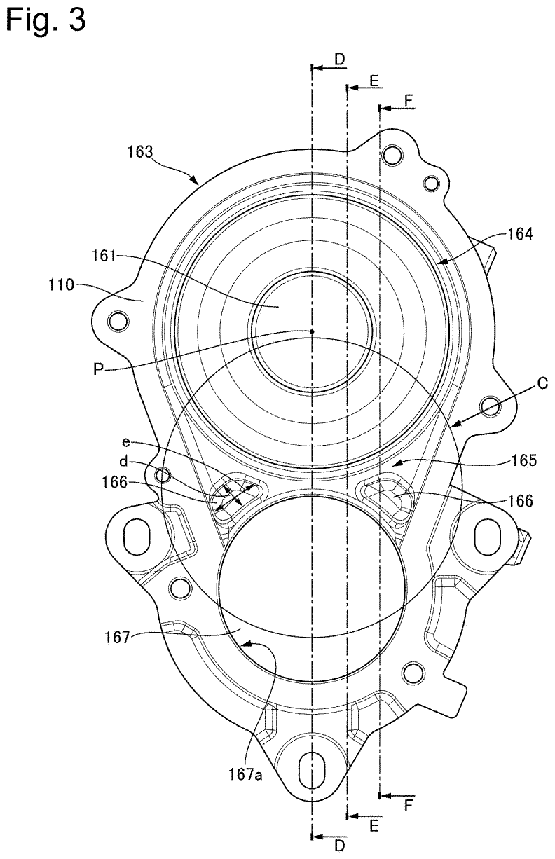

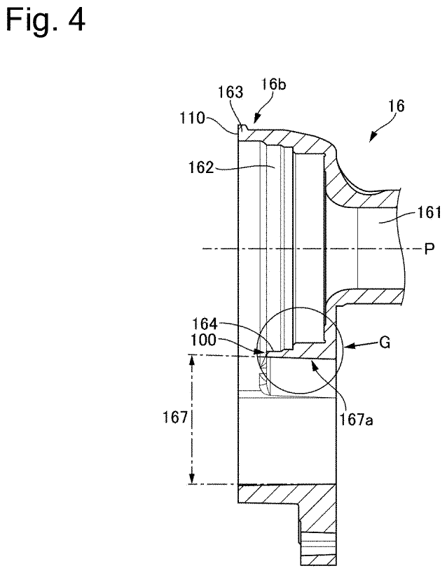

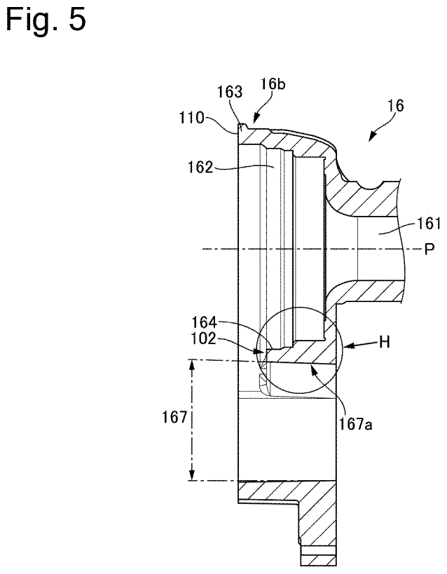

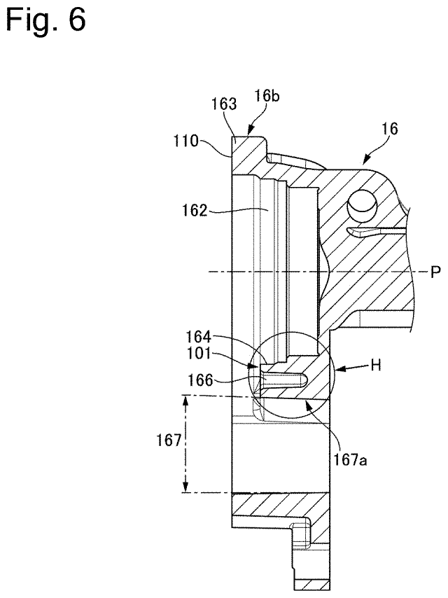

FIG. 3 is a plan view of the first housing according to the first embodiment as viewed from its second end portion side. FIG. 4 is a sectional view taken along the line D-D of FIG. 3 as viewed in a direction of arrows. FIG. 5 is a sectional view taken along the line E-E of FIG. 3 as viewed in a direction of arrows. FIG. 6 is a sectional view taken along the line F-F of FIG. 3 as viewed in a direction of arrows.

(Specific Structure of First Housing)

The first housing 16 includes an intermediation portion 165 between the female thread portion 164 and the inner peripheral surface 167a of the electric motor shaft insertion hole portion 167. The intermediate portion 165 is located on a side closer to the first end portion 16a of the first housing 16 with respect to the extended portion 163, and is continuous with the extended portion 163.

The intermediate portion 165 has a pair of recessed portions 166, each having a bottom portion. The pair of recessed portions 166 are recessed toward the first end portion 16a of the first housing 16.

As described above, the presence of the pair of recessed portions 166 can reduce a weight of the first housing 16 and prevent formation of a blowhole.

Further, the pair of recessed portions 166 each have a bottom portion, and thus do not pass through the intermediate portion 165. Thus, when the motor housing 31 is fastened to the first housing 16, the first housing 16 can be used as a seat surface for sealing.

Further, the pair of recessed portions 166 are arranged in a circumferential direction of the electric motor shaft insertion hole portion 167 so that each of the recessed portions 166 extends along the electric motor shaft insertion hole portion 167.

Further, a length “e” of each of the recessed portions 166 in the circumferential direction of the motor shaft insertion hole portion 167 is set larger than a length “d” of each of the recessed portions 166 in a radial direction of the electric motor shaft insertion hole portion 167.

Thus, when the length “d” of each of the recessed portions 166 in the radial direction of the electric motor shaft insertion hole portion 167 is set excessively large, a portion of each of the recessed portions 166 is tapered in a direction away from the electric motor shaft insertion hole portion 167, which may result in lowered durability of a molding die for forming the recessed portions 166. However, the length “d” of each of the recessed portions 166 in the radial direction of the electric motor shaft insertion hole portion 167 is set smaller than the length “e” of each of the recessed portions 166 in the circumferential direction of the motor shaft insertion hole portion 167. Thus, the durability of the molding die for forming the recessed portions 166 can be prevented from being lowered.

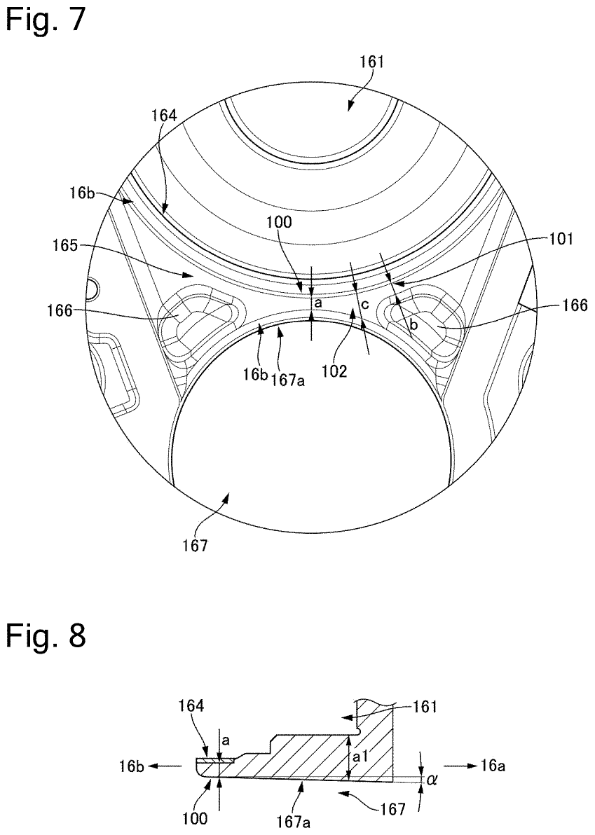

FIG. 7 is an enlarged view of an area C of FIG. 3.

When the axis P extending in the longitudinal direction of the rack bar 6 is viewed from the radially outer side, the inner peripheral surface 167a of the electric motor shaft insertion hole portion 167 extends to such a position as to be opposed to the female thread portion 164 (see FIG. 4). A length “b” of a second proximity portion 101 is set larger than a length “a” of a first proximity portion 100. At the second proximity portion 101, the rack bar insertion hole portion 161 on the second end portion 16b side and the recessed portion 166 on the second end portion 16b side are the closest to each other. At the first proximity portion 100, the rack bar insertion hole portion 161 on the second end portion 16b side and the electric motor shaft insertion hole portion 167 on the second end portion 16b side are the closest to each other.

In the above-mentioned manner, the first proximity portion 100 can be supported in an arch-like fashion by the electric motor shaft insertion hole portion 167. The second proximity portion 101 has lowered strength due to the presence of the recessed portion 166. Thus, when the length “b” of the second proximity portion 101 is set larger than the length “a” of the first proximity portion 100, the strength of the second proximity portion 101 can be prevented from being lowered.

Further, when the axis P extending in the longitudinal direction of the rack bar 6 is viewed from the radially outer side, the inner peripheral surface 167a of the electric motor shaft insertion hole portion 167 extends to such a position as to be opposed to the female thread portion 164 (see FIG. 5). The length “a” of the first proximity portion 100 is set shorter than a length “c” of a third proximity portion 102. At the first proximity portion 100, the rack bar insertion hole portion 161 on the second end portion 16b side and the electric motor shaft insertion hole portion 167 on the second end portion 16b side are the closest to each other. The third proximity portion 102 between the rack bar insertion hole portion 161 on the second end portion 16b side and the electric motor shaft insertion hole portion 167 on the second end portion 16b side is located on a side of the first proximity portion 100, which is closer to the recessed portion 166 in a circumferential direction about the axis P extending in the longitudinal direction of the rack bar 6. At the third proximity portion 102, the rack bar insertion hole portion 161 on the second end portion 16b side and the electric motor shaft insertion hole portion 167 on the second end portion 16b side are in proximity to each other.

In this manner, when a thickness is set to gradually increase from the first proximity portion 100 toward the third proximity portion 102, stress concentration in the first proximity portion 100 can be eased.

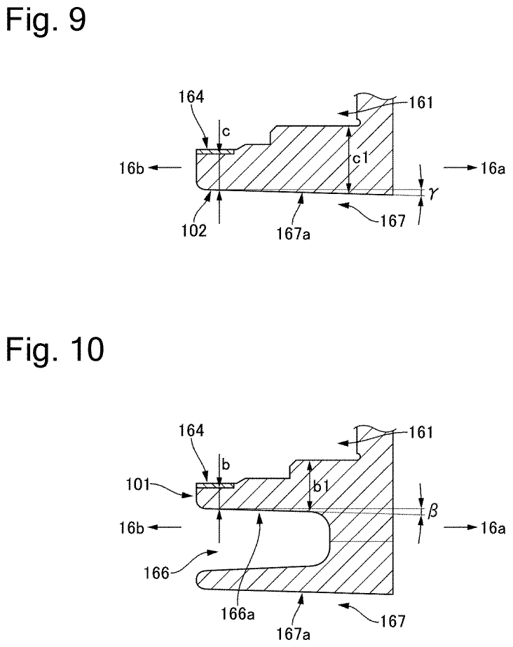

FIG. 8 is an enlarged sectional view of an area G of FIG. 4. FIG. 9 is an enlarged sectional view of an area H of FIG. 5. FIG. 10 is an enlarged sectional view of an area I of FIG. 6.

As illustrated in FIG. 8, when the axis P extending in the longitudinal direction of the rack bar 6 is viewed from the radially outer side, the inner peripheral surface 167a of the electric motor shaft insertion hole portion 167 extends to such a position as to be opposed to the female thread portion 164. The inner peripheral surface 167a of the electric motor shaft insertion hole portion 167 is inclined by an angle α in the direction of the axis P extending in the longitudinal direction of the rack bar 6 toward the first end portion 16a. The length “a” of the first proximity portion 100 on the second end portion 16b side between the rack bar insertion hole portion 161 and the electric motor shaft insertion hole portion 167 is set to gradually increase to a length al of the first proximity portion 100 on the first end portion 16a side in the direction of the axis P extending in the longitudinal direction of the rack bar 6 (a1>“a”).

As described above, the first proximity portion 100 is formed so as to become gradually larger from the second end portion side in the direction of the axis P extending in the longitudinal direction of the rack bar 6 toward the first end portion 16a. Thus, the first proximity portion 100 is less liable to be bent. As a result, an internal stress in the first proximity portion 100 on the first end portion 16a side in the direction of the axis P extending in the longitudinal direction of the rack bar 6 can be eased.

Further, as illustrated in FIG. 9, the inner peripheral surface 167a of the electric motor shaft insertion hole portion 167 is inclined by an angle γ in the direction of the axis P extending in the longitudinal direction of the rack bar 6 toward the first end portion 16a. The length “c” of the third proximity portion 102 on the second end portion 16b side between the rack bar insertion hole portion 161 and the electric motor shaft insertion hole portion 167 is set to gradually increase to a length c1 of the third proximity portion 102 on the first end portion 16a side in the direction of the axis P extending in the longitudinal direction of the rack bar 6 (c1>“c”). As a result, an internal stress in the third proximity portion 102 on the first end portion 16a side in the direction of the axis P extending in the longitudinal direction of the rack bar 6 can be eased.

Further, as illustrated in FIG. 10, when the axis P extending in the longitudinal direction of the rack bar 6 is viewed from the radially outer side, the inner peripheral surface 167a of the electric motor shaft insertion hole portion 167 and an inner peripheral surface 166a of the recessed portion 166 extend to such positions as to be opposed to the female thread portion 164. The inner peripheral surface 166a of the recessed portion 166 is inclined by an angle in the direction of the axis P extending in the longitudinal direction of the rack bar 6 toward the first end portion 16a. The length “b” of the second proximity portion 101 on the second end portion 16b side between the rack bar insertion hole portion 161 and the recessed portion 166 is set to gradually increase to a length b1 of the second proximity portion 101 on the first end portion 16a side in the direction of the axis P extending in the longitudinal direction of the rack bar 6 (b1>″b″).

As described above, the length of the second proximity portion 101 on the second end portion 16b side between the rack bar insertion hole portion 161 and the recessed portion 166 is set to gradually increase in the direction of the axis P extending in the longitudinal direction of the rack bar 6 toward the first end portion 16a. Thus, the second proximity portion 101 is less liable to be bent. As a result, an internal stress in the second proximity portion 101 between the rack bar insertion hole portion 161 and the recessed portion 166 on the first end portion 16a side in the direction of the axis P extending in the longitudinal direction of the rack bar 6 can be eased.

Next, actions and effects are described.

Actions and effects of the steering load control device 1 according to the first embodiment are given below. (1) The first housing 16 has the rack bar insertion hole portion 161, the electric motor shaft insertion hole portion 167, and the female thread portion (fastening portion) 164. The rack bar 6 is inserted through the rack bar insertion hole portion 161 in the longitudinal direction of the rack bar 6. The electric motor shaft insertion hole portion 167 is formed on a radially outer side of the rack bar insertion hole portion 161. The electric motor shaft 8, which is supported in an electric motor housing 31 and extends from the electric motor 3, is inserted through the electric motor shaft insertion hole portion 167 having a cylindrical shape. In the rack bar insertion hole portion 167, when the axis P extending in the longitudinal direction of the rack bar 6 is viewed from the radially outer side, the female thread portion 164 having an annular shape overlaps with the inner peripheral surface 167a of the electric motor shaft insertion hole portion 167 in the longitudinal direction of the rack bar 6. The lock nut 40 that fixes the ball screw mechanism 4 into the rack bar insertion hole portion 167 is threadedly engaged with the female thread portion 164.

Accordingly, the female thread portion 164 has a continuous annular shape. Thus, the female thread portion 164 can be prevented from being deformed in such a manner as to increase its diameter under a fastening load that is applied when the lock nut 40 is threadedly engaged therewith. The inner peripheral surface of the electric motor shaft insertion hole portion 167 having a cylindrical shape also has a continuous annular shape. Thus, the electric motor shaft insertion hole portion 167 has such a structure as to resist against the female thread portion 164 that is being deformed to increase its diameter under a fastening load that is applied when the lock nut 40 is threadedly engaged with the female thread portion 164. Thus, the female thread portion 164 can be further prevented from being deformed in such a manner as to increase its diameter.

(2) The first housing 16 and the second housing 17 have the joint surface 110 at which the second end portion 16b side of the mechanism accommodating portion 162 of the first housing 16 and the first end portion 17a side of the closing portion 172 of the second housing 17 are connected to each other with use of a plurality of bolts (not shown). The joint surface 110 is defined on an extended portion 163 that is closer to the second end portion 16b of the first housing 16 than the female thread portion 164 is.

Thus, the presence of the extended portion 163, on which a fastening load does not directly act when the lock nut 40 is threadedly engaged with the female thread portion 164, can further reliably prevent the female thread portion 164 from being deformed in such a manner as to increase its diameter under a fastening load that is applied when the lock nut 40 is threadedly engaged therewith.

(3) The first housing 16 includes the intermediation portion 165 between the female thread portion 164 and the inner peripheral surface 167a of the electric motor shaft insertion hole portion 167. The intermediate portion 165 is located on a side closer to the first end portion 16a of the first housing 16 with respect to the extended portion 163, and is continuous with the extended portion 163. The intermediate portion 165 has the pair of recessed portions 166, each having a bottom portion. The pair of recessed portions 166 are recessed toward the first end portion 16a of the first housing 16.

Thus, the presence of the pair of recessed portions 166 can reduce a weight of the first housing 166 and prevent formation of a blowhole.

(4) When the axis P extending in the longitudinal direction of the rack bar 6 is viewed from the radially outer side, the inner peripheral surface 167a of the electric motor shaft insertion hole portion 167 extends to such a position as to be opposed to the female thread portion 164. The length “b” of the second proximity portion 101 is set larger than the length “a” of the first proximity portion 100. At the second proximity portion 101, the rack bar insertion hole portion 161 on the second end portion 16b side and the recessed portion 166 on the second end portion 16b side are the closest to each other. At the first proximity portion 100, the rack bar insertion hole portion 161 on the second end portion 16b side and the electric motor shaft insertion hole portion 167 on the second end portion 16b side are the closest to each other.

Thus, the first proximity portion 100 can be supported in an arch-like fashion by the electric motor shaft insertion hole portion 167. The second proximity portion 101 has lowered strength due to the presence of the recessed portion 166. Thus, when the length “b” of the second proximity portion 101 is set larger than the length “a” of the first proximity portion 100, the strength of the second proximity portion 101 can be prevented from being lowered.

(5) The pair of recessed portions 166 each have the bottom portion.

The recessed portions 166 thus do not pass through the intermediate portion 165. Thus, when the motor housing 31 is fastened to the first housing 16, the first housing 16 can be used as a seat surface for sealing.

(6) When the axis P extending in the longitudinal direction of the rack bar 6 is viewed from the radially outer side, the inner peripheral surface 167a of the electric motor shaft insertion hole portion 167 extends to such a position as to be opposed to the female thread portion 164. The length “a” of the first proximity portion 100 is set shorter than the length “c” of a third proximity portion 102. At the first proximity portion 100, the rack bar insertion hole portion 161 on the second end portion 16b side and the electric motor shaft insertion hole portion 167 on the second end portion 16b side are the closest to each other. At the first proximity portion 100, the rack bar insertion hole portion 161 on the second end portion 16b side and the electric motor shaft insertion hole portion 167 on the second end portion 16b side are the closest to each other. The third proximity portion 102 is located on a side of the first proximity portion 100, which is closer to the recessed portion 166 in the circumferential direction about the axis P extending in the longitudinal direction of the rack bar 6. At the third proximity portion 102, the rack bar insertion hole portion 161 on the second end portion 16b side and the electric motor shaft insertion hole portion 167 on the second end portion 16b side are in proximity to each other.

Thus, when a thickness is set to gradually increase from the first proximity portion 100 toward the third proximity portion 102, stress concentration in the first proximity portion 100 can be eased.

(7) Further, the length “e” of each of the recessed portions 166 in the circumferential direction of the motor shaft insertion hole portion 167 is set larger than the length “d” of each of the recessed portions 166 in the radial direction of the electric motor shaft insertion hole portion 167.

Thus, when the length “d” of each of the recessed portions 166 in the radial direction of the electric motor shaft insertion hole portion 167 is set excessively large, a portion of each of the recessed portions 166 is tapered in the direction away from the electric motor shaft insertion hole portion 167, which may result in lowered durability of a molding die for forming the recessed portions 166. However, the length “d” of each of the recessed portions 166 in the radial direction of the electric motor shaft insertion hole portion 167 is set smaller than the length “e” of each of the recessed portions 166 in the circumferential direction of the motor shaft insertion hole portion 167. Thus, the durability of the molding die for forming the recessed portions 166 can be prevented from being lowered.

(8) When the axis P extending in the longitudinal direction of the rack bar 6 is viewed from the radially outer side, the inner peripheral surface 167a of the electric motor shaft insertion hole portion 167 extends to such a position as to be opposed to the female thread portion 164. The inner peripheral surface 167a of the electric motor shaft insertion hole portion 167 is inclined by the angle a in the direction of the axis P extending in the longitudinal direction of the rack bar 6 toward the first end portion 16a. The length “a” of the first proximity portion 100 on the second end portion 16b side between the rack bar insertion hole portion 161 and the electric motor shaft insertion hole portion 167 is set to gradually increase to the length al of the first proximity portion 100 on the first end portion 16a side in the direction of the axis P extending in the longitudinal direction of the rack bar 6 (a1>“a”).

Accordingly, the first proximity portion 100 is formed so as to become gradually larger in the direction of the axis P extending in the longitudinal direction of the rack bar 6 toward the first end portion 16a. Thus, the first proximity portion 100 is less liable to be bent. As a result, an internal stress in the first proximity portion 100 on the first end portion 16a side in the direction of the axis P extending in the longitudinal direction of the rack bar 6 can be eased.

(9) The inner peripheral surface 167a of the electric motor shaft insertion hole portion 167 is inclined by the angle y in the direction of the axis P extending in the longitudinal direction of the rack bar 6 toward the first end portion 16a. The length “c” of the third proximity portion 102 on the second end portion 16b side between the rack bar insertion hole portion 161 and the electric motor shaft insertion hole portion 167 is set to gradually increase to a length cl of the third proximity portion 102 on the first end portion 16a side in the direction of the axis P extending in the longitudinal direction of the rack bar 6 (c1>″c″).

Thus, an internal stress in the third proximity portion 102 on the first end portion 16a side in the direction of the axis P extending in the longitudinal direction of the rack bar 6 can be eased.

(10) When the axis P extending in the longitudinal direction of the rack bar 6 is viewed from the radially outer side, the inner peripheral surface 167a of the electric motor shaft insertion hole portion 167 extends to such positions as to be opposed to the female thread portion 164. The inner peripheral surface 166a of the recessed portion 166 is inclined by the angle _{R} in the direction of the axis P extending in the longitudinal direction of the rack bar 6 toward the first end portion 16a. The length “b” of the second proximity portion 101 on the second end portion 16b side between the rack bar insertion hole portion 161 and the recessed portion 166 is set to gradually increase to a length b1 of the second proximity portion 101 on the first end portion 16a side in the direction of the axis P extending in the longitudinal direction of the rack bar 6 (b1>″b″).

Thus, the length of the second proximity portion 101 on the second end portion 16b side between the rack bar insertion hole portion 161 and the recessed portion 166 is set to gradually increase in the direction of the axis P extending in the longitudinal direction of the rack bar 6 toward the first end portion 16a. Thus, the second proximity portion 101 is less liable to be bent. As a result, an internal stress in the second proximity portion 101 between the rack bar insertion hole portion 161 and the recessed portion 166 on the first end portion 16a side in the direction of the axis P extending in the longitudinal direction of the rack bar 6 can be eased.

### Other Embodiments

The embodiment of the present invention has been described above. However, the specific configuration of the present invention is not limited to the configuration described in the embodiment. A change in design without departing from the scope of the gist of the invention is also encompassed in the present invention.

Technical ideas obtained from the embodiments described above are listed below.

According to one aspect, there is provided a housing for an electric power steering device, the electric power steering device including: an electric motor; a speed reduction mechanism configured to reduce a speed of an output from the electric motor; a ball screw mechanism configured to convert a rotational motion transmitted from the speed reduction mechanism into a linear motion; and a rack bar connected to the ball screw mechanism, the housing including: a first housing having a first end portion configured to cover a part of the rack bar and a second end portion with a mechanism accommodating portion configured to accommodate at least a part of the speed reduction mechanism and the ball screw mechanism; and a second housing having a first end portion with a closing portion configured to close the mechanism accommodating portion and a second end portion configured to cover a part of the rack bar. The first housing includes: a rack bar insertion hole portion through which the rack bar is inserted in a longitudinal direction of the rack bar; an electric motor shaft insertion hole portion having a cylindrical shape on a radially outer side of the rack bar insertion hole portion, through which an electric motor shaft extending from the electric motor is inserted; and a fastening portion having an annular shape, which overlaps with an inner peripheral surface of the electric motor shaft insertion hole portion in the longitudinal direction of the rack bar when an axis extending in the longitudinal direction of the rack bar is viewed from a radially outer side, and is configured to allow the ball screw mechanism to be fixed into the rack bar insertion hole portion.

According to a more preferred aspect, in the above-mentioned aspect, the first housing and the second housing have a joint surface at which a second end portion side of the mechanism accommodating portion of the first housing and a first end portion side of the closing portion of the second housing are jointed together, and the joint surface is defined on an extended portion of the first housing, which is closer to the second end portion of the first housing than the fastening portion is.

According to a more preferred aspect, in the above-mentioned aspect, the housing for an electric power steering device includes an intermediate portion continuous with the extended portion, which is located on the first end portion side of the extended portion and between the fastening portion and the inner peripheral surface of the electric motor shaft insertion hole portion, and the intermediate portion has recessed portions recessed toward the first end portion of the first housing.

According to a more preferred aspect, in the above-mentioned aspect, the inner peripheral surface of the electric motor shaft insertion hole portion extends to such a position as to be opposed to the fastening portion when the axis extending in the longitudinal direction of the rack bar is viewed from the radially outer side, and a length of a second proximity portion at which the rack bar insertion hole portion on the second end portion side of the first housing and the recessed portion on the second end portion side of the first housing are the closest to each other is set larger than a length of a first proximity portion at which the rack bar insertion hole portion on the second end portion side of the first housing and the electric motor shaft insertion hole portion on the second end portion side of the first housing are the closest to each other.

According to still another preferred aspect, in any one of above-mentioned aspects, each of the recessed portions has a bottom portion.

According to still another preferred aspect, in any one of the above-mentioned aspects, the inner peripheral surface of the electric motor shaft insertion hole portion extends to such a position as to be opposed to the fastening portion when the axis extending in the longitudinal direction of the rack bar is viewed from the radially outer side, and a length of a first proximity portion at which the rack bar insertion hole portion on the second end portion side of the first housing and the electric motor shaft insertion hole portion on the second end portion side of the first housing are the closest to each other is set smaller than a length of a third proximity portion, which is located on a side closer to the recessed portion in a circumferential direction about the axis extending in the longitudinal direction of the rack bar with respect to the first proximity portion, and at which the rack bar insertion hole portion on the second end portion side of the first housing and the electric motor shaft insertion hole portion on the second end portion side of the first housing are in proximity to each other.

According to still another preferred aspect, in any one of the above-mentioned aspects, the recessed portions are arranged in a circumferential direction of the electric motor shaft insertion hole portion, and each extend along the electric motor shaft insertion hole portion, and a length of each of the recessed portions in the circumferential direction of the electric motor shaft insertion hole is set larger than a length of each of the recessed portions in a radial direction of the electric motor shaft insertion hole.

According to still another preferred aspect, in any one of the above-mentioned aspects, the inner peripheral surface of the electric motor shaft insertion hole portion extends to such a position as to be opposed to the fastening portion when the axis extending in the longitudinal direction of the rack bar is viewed from the radially outer side, and a length of the first proximity portion or the third proximity portion between the rack bar insertion hole portion and the electric motor shaft insertion hole portion gradually increases from the second end portion side of the first housing toward the first end portion of the first housing.

According to still another preferred aspect, in any one of the above-mentioned aspects, the inner peripheral surface of the electric motor shaft insertion hole portion and an inner peripheral surface of each of the recessed portions extend to such positions as to be opposed to the fastening portion when the axis extending in the longitudinal direction of the rack bar is viewed from the radially outer side, and a length of the second proximity portion between the electric motor shaft insertion hole portion and the recessed portion gradually increases from the second end portion side of the first housing toward the first end portion of the first housing.

Note that, the present invention is not limited to the embodiments described above, and includes further various modification examples. For example, in the embodiments described above, the configurations are described in detail in order to clearly describe the present invention, but the present invention is not necessarily limited to an embodiment that includes all the configurations that have been described. Further, a part of the configuration of a given embodiment can replace the configuration of another embodiment, and the configuration of another embodiment can also be added to the configuration of a given embodiment. Further, another configuration can be added to, deleted from, or replace a part of the configuration of each of the embodiments.

The present application claims a priority based on Japanese Patent Application No. 2020-024500 filed on Feb. 17, 2020. All disclosed contents including Specification, Scope of Claims, Drawings, and Abstract of Japanese Patent Application No. 2020-024500 filed on Feb. 17, 2020 are incorporated herein by reference in their entirety.

### REFERENCE SIGNS LIST

1 electric power steering device, 3 electric motor, 3a electric motor shaft, 4 ball screw mechanism, 5 housing, 6 rack bar, 7 speed reduction mechanism, 16 first housing, 16a first end portion, 16b second end portion, 161 rack bar insertion hole portion, 162 mechanism accommodating portion, 163 extended portion 164 female thread portion (fastening portion), 165 intermediation portion, 166 recessed portion, 167 electric motor shaft insertion hole portion, 167a inner peripheral surface, 17 second housing, 17a first end portion, 17b second end portion, 172 closing portion, 100 first proximity portion, 101 second proximity portion, 102 third proximity portion, 110 joint surface, a length of first proximity portion on second end portion of first housing, a1 length of first proximity portion on first end portion of first housing, b length of second proximity portion on second end portion of first housing, b1 length of second proximity portion on first end portion of first housing, c length of third proximity portion on second end portion of first housing, c1 length of third proximity portion on second end portion of first housing, d length of recessed portion in radial direction of electric motor shaft insertion hole portion, e length of recessed portion in circumferential direction of electric motor shaft insertion hole portion, P axis extending in longitudinal direction of rack bar

1. A housing for an electric power steering device, the electric power steering device comprising:
an electric motor;
a speed reduction mechanism configured to reduce a speed of an output from the electric motor;
a ball screw mechanism configured to convert a rotational motion transmitted from the speed reduction mechanism into a linear motion; and
a rack bar connected to the ball screw mechanism,
the housing comprising:
a first housing having a first end portion configured to cover a part of the rack bar and a second end portion with a mechanism accommodating portion configured to accommodate at least a part of the speed reduction mechanism and the ball screw mechanism; and
a second housing having a first end portion with a closing portion configured to close the mechanism accommodating portion and a second end portion configured to cover a part of the rack bar,
wherein the first housing includes:
a rack bar insertion hole portion through which the rack bar is inserted in a longitudinal direction of the rack bar;
an electric motor shaft insertion hole portion having a cylindrical shape on a radially outer side of the rack bar insertion hole portion, through which an electric motor shaft extending from the electric motor is inserted; and
a fastening portion having an annular shape, which overlaps with an inner peripheral surface of the electric motor shaft insertion hole portion in the longitudinal direction of the rack bar when an axis extending in the longitudinal direction of the rack bar is viewed from a radially outer side, and is configured to allow the ball screw mechanism to be fixed into the rack bar insertion hole portion.

2. The housing for an electric power steering device according to claim 1,
wherein the first housing and the second housing have a joint surface at which a second end portion side of the mechanism accommodating portion of the first housing and a first end portion side of the closing portion of the second housing are jointed together, and
wherein the joint surface is defined on an extended portion of the first housing, which is closer to the second end portion of the first housing than the fastening portion is.

3. The housing for an electric power steering device according to claim 2, further comprising an intermediate portion continuous with the extended portion, which is located on the first end portion side of the extended portion and between the fastening portion and the inner peripheral surface of the electric motor shaft insertion hole portion,
wherein the intermediate portion has recessed portions recessed toward the first end portion of the first housing.

4. The housing for an electric power steering device according to claim 3,
wherein the inner peripheral surface of the electric motor shaft insertion hole portion extends to such a position as to be opposed to the fastening portion when the axis extending in the longitudinal direction of the rack bar is viewed from the radially outer side, and
wherein a length of a second proximity portion at which the rack bar insertion hole portion on the second end portion side of the first housing and the recessed portion on the second end portion side of the first housing are the closest to each other is set larger than a length of a first proximity portion at which the rack bar insertion hole portion on the second end portion side of the first housing and the electric motor shaft insertion hole portion on the second end portion side of the first housing are the closest to each other.

5. The housing for an electric power steering device according to claim 3, wherein each of the recessed portions has a bottom portion.

6. The housing for an electric power steering device according to claim 3,
wherein the inner peripheral surface of the electric motor shaft insertion hole portion extends to such a position as to be opposed to the fastening portion when the axis extending in the longitudinal direction of the rack bar is viewed from the radially outer side, and
wherein a length of a first proximity portion at which the rack bar insertion hole portion on the second end portion side of the first housing and the electric motor shaft insertion hole portion on the second end portion side of the first housing are the closest to each other is set smaller than a length of a third proximity portion, which is located on a side closer to the recessed portion in a circumferential direction about the axis extending in the longitudinal direction of the rack bar with respect to the first proximity portion, and at which the rack bar insertion hole portion on the second end portion side of the first housing and the electric motor shaft insertion hole portion on the second end portion side of the first housing are in proximity to each other.

7. The housing for an electric power steering device according to claim 3,
wherein the recessed portions are arranged in a circumferential direction of the electric motor shaft insertion hole portion, and each extend along the electric motor shaft insertion hole portion, and
wherein a length of each of the recessed portions in the circumferential direction of the electric motor shaft insertion hole portion is set larger than a length of each of the recessed portions in a radial direction of the electric motor shaft insertion hole portion.

8. The housing for an electric power steering device according to claim 3,
wherein the inner peripheral surface of the electric motor shaft insertion hole portion extends to such a position as to be opposed to the fastening portion when the axis extending in the longitudinal direction of the rack bar is viewed from the radially outer side, and
wherein a length of the first proximity portion or the third proximity portion between the rack bar insertion hole portion and the electric motor shaft insertion hole portion gradually increases from the second end portion side of the first housing toward the first end portion of the first housing.

9. The housing for an electric power steering device according to claim 3,
wherein the inner peripheral surface of the electric motor shaft insertion hole portion and an inner peripheral surface of each of the recessed portions extend to such positions as to be opposed to the fastening portion when the axis extending in the longitudinal direction of the rack bar is viewed from the radially outer side, and
wherein a length of the second proximity portion between the electric motor shaft insertion hole portion and the recessed portion gradually increases from the second end portion side of the first housing toward the first end portion of the first housing.
